(19) United States
(12) Patent Application Publication
(10) Pub. No.: US 2026/0183944 A1
(43) Pub. Date: Jul. 2, 2026

(54) ASSISTANCE DEVICE AND ROBOT SYSTEM

(71) Applicant: YAMAHA HATSUDOKI KABUSHIKI KAISHA, Iwata-shi, Shizuoka (JP)

(72) Inventor: Tomoki HARADA, Shizuoka (JP)

(73) Assignee: YAMAHA HATSUDOKI KABUSHIKI KAISHA, Iwata-shi, Shizuoka (JP)

(21) Appl. No.: 18/857,675

(22) PCT Filed: Jun. 15, 2022
(86) PCT No.: PCT/JP2022/023999

§ 371 Date: Oct. 17, 2024

(51) Int. Cl. B25J 9/16

(52) U.S. Cl. CPC B25J 9/1633; B25J 9/1653

(57) ABSTRACT

An assistance device is a device that assists in creating setting data about control of a robot equipped with a robot arm including arm elements and joint parts. The assistance device includes a display unit and a control unit that controls the display unit. The control unit performs an acquisition process and a display process. The control unit acquires data of joint acting force indicating force acting on each of the plurality of joint parts and data of specific point acting force indicating force acting on a specific point at the distal end of the robot arm in the acquisition process. The control unit controls the display unit to display a joint acting force waveform indicating a temporal change in each joint acting force and a specific point acting force waveform indicating a temporal change in the specific point acting force in the display process.

### CROSS-REFERENCE TO RELATED APPLICATION

This application claims benefit of priority to International Patent Application No. PCT/JP2022/023999, filed Jun. 15, 2022, the entire contents of which are incorporated herein by reference.

### BACKGROUND

### Technical Field

The present disclosure relates to an assistance device that assists in creating setting data about control of a robot and a robot system including the same.

### Background Art

A robot equipped with a robot arm with arms pivotably connected to a plurality of joint parts has been conventionally known. In such a robot, parameter setting about control of a robot is performed such that the robot arm performs desired operations.

Japanese Patent No. 6582483 discloses a technology for assisting in setting parameters about control of a robot. In the technology disclosed in Japanese Patent No. 6582483, the acting force acting on a specific point at the distal end of a robot arm (tool center point; TCP) on which an end effector is mounted is detected by a force detector. Then, a detection waveform indicating the temporal change in a detection value detected by the force detector and a storage waveform about the acting force stored in advance in a storage medium are displayed in a display unit, and parameter settings are received by a reception unit.

In the technology disclosed in Japanese Patent No. 6582483, only the temporal change in the acting force acting on the specific point at the distal end of the robot arm based on the detected waveform and the stored waveform displayed in the display unit is an indicator for setting parameters. Therefore, there is a risk that the parameters about control of a robot cannot be set in detail.

### SUMMARY

Accordingly, the present disclosure provides an assistance device that can set parameters about control of a robot in detail and a robot system.

An assistance device according to one aspect of the present disclosure is a device that assists in setting a parameter about control of a robot equipped with a robot arm including a plurality of arm elements and a plurality of joint parts that connects the plurality of arm elements pivotably around a pivoting axis, and includes a display unit and a control unit that controls the display unit. The control unit performs an acquisition process of acquiring data of joint acting force indicating force acting on each of the plurality of joint parts, and data of specific point acting force indicating force acting on a specific point at a distal end of the robot arm; and a display process of controlling the display unit to display a joint acting force waveform indicating a temporal change in each of the joint acting force and a specific point acting force waveform indicating a temporal change in the specific point acting force.

A robot system according to another aspect of the present disclosure includes a robot equipped with a robot arm including a plurality of arm elements and a plurality of joint parts that connects the plurality of arm elements pivotably around a pivoting axis; and the assistance device that assists in creating setting data about control of the robot.

The object, features, and advantages of the present disclosure will be more apparent from the following detailed description and the accompanying drawings.

### BRIEF DESCRIPTION OF THE DRAWINGS

FIG. 1 is a block diagram of a robot system according to an embodiment of the present disclosure;

FIG. 2 is a perspective view of a robot provided in the robot system;

FIG. 3 is a cross-sectional view of a joint part in a robot arm of the robot;

FIG. 4 is a diagram showing data acquired by a control unit of an assistance device provided in the robot system in an acquisition process;

FIG. 5 is a diagram showing a display screen on which the control unit of the assistance device causes a display unit to display in a display process;

FIG. 6 is a diagram describing a recognition process performed by the control unit of the assistance device.

### DETAILED DESCRIPTION

An assistance device and a robot system according to an embodiment of the present disclosure will be described below with reference to the drawings.

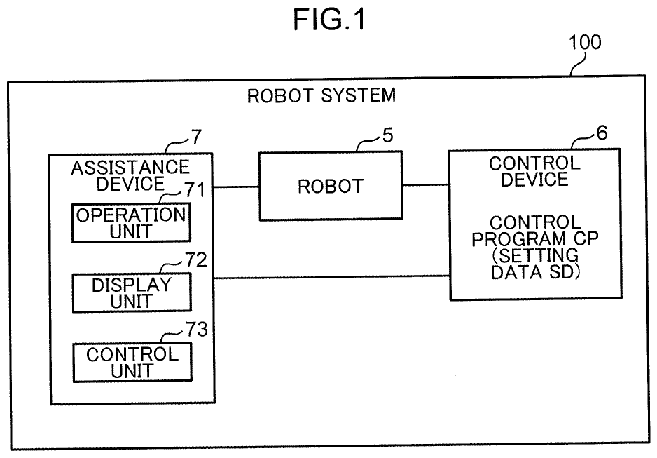

As shown in FIG. 1, a robot system 100 according to the present embodiment includes a robot 5, a control device 6, and an assistance device 7. In the robot system 100, the assistance device 7 assists in setting parameters about the control of the robot 5. An operator of the robot system 100 can use the assistance device 7 to set the parameters about the control of the robot 5. The control device 6 controls the operation of the robot 5 by transmitting a control signal according to a control program CP that records setting data SD created based on the parameter setting to the robot 5.

### [Configuration of Robot]

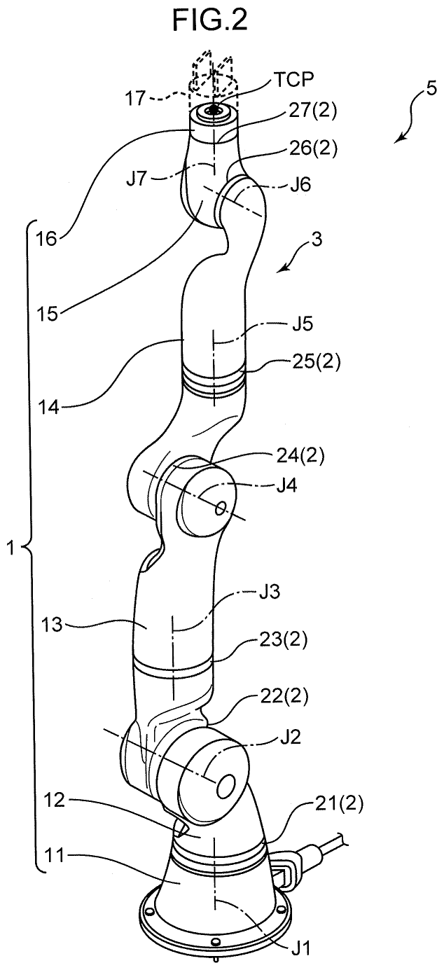

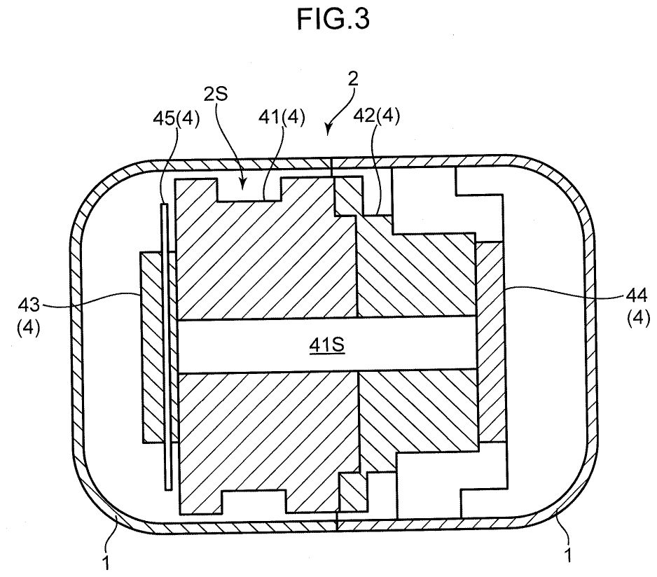

The robot 5 will be described with reference to FIGS. 2 and 3 in addition to FIG. 1. As shown in FIG. 2, the robot 5 is, for example, a vertical seven-axis articulated robot. The robot 5 includes a robot arm 3 having a first axis J1, a second axis J2, a third axis J3, a fourth axis J4, a fifth axis J5, a sixth axis J6, and a seventh axis J7 as seven pivoting axes. The robot arm 3 includes a base unit 11, a barrel unit 12, a first arm 13, a second arm 14, a third arm 15, and a head unit 16 as a plurality of arm elements 1. In addition, the robot arm 3 includes a first joint part 21, a second joint part 22, a third joint part 23, a fourth joint part 24, a fifth joint part 25, a sixth joint part 26, and a seventh joint part 27 as a plurality of joint parts 2.

The base unit 11 is a housing that is fixed onto the floor, pedestal, or the like. The barrel unit 12 is connected to the upper surface of the base unit 11 via the first joint part 21. The barrel unit 12 is pivotable in both forward and reverse directions around the first axis J1 extending vertically by the first joint part 21. The first arm 13 has a predetermined length and the proximal end thereof is connected to the barrel unit 12 via the second joint part 22. The first arm 13 is swingable around the second axis J2 extending horizontally by the second joint part 22. The first arm 13 includes the third joint part 23 in its midway. The distal end piece of the first arm 13 is pivotable around the third axis J3 extending in the arm axial direction by the third joint part 23.

The second arm 14 is an arm connected below the first arm 13, and the proximal end thereof is connected to the distal end of the first arm 13 via the fourth joint part 24. The second arm 14 is swingable around the fourth axis J4 extending horizontally by the fourth joint part 24. The second arm 14 includes the fifth joint part 25 in its midway. The distal end piece of the second arm 14 is pivotable around the fifth axis J5 extending in the arm axial direction by the fifth joint part 25. The third arm 15 is an arm connected below the second arm 14, and the proximal end thereof is connected to the distal end of the second arm 14 via the sixth joint part 26. The third arm 15 is swingable around the sixth axis J6 extending horizontally by the sixth joint part 26.

The head unit 16 is connected to the distal end of the third arm 15 via the seventh joint part 27. The head unit 16 is pivotable around the seventh axis J7 extending vertically by the seventh joint part 27. The head unit 16 constitutes the distal end of the robot arm 3, and an end effector 17 is mounted. The end effector 17 is, for example, a tool such as a screwdriver, gripper, and grinder. The end effector 17 can perform, for example, various works such as screw fastening, gripping, and processing.

A specific point (tool center point) TCP that serves as a reference for the position of the end effector 17 is set on the head unit 16, which is the distal end of the robot arm 3. The position of the specific point TCP on the head unit 16 can be set at an arbitrary position, and is set, for example, on the seventh axis J7, which is the pivoting axis of the head unit 16.

In the robot arm 3, the first joint part 21, the third joint part 23, the fifth joint part 25, and the seventh joint part 27 have a housing shape of a vertically extending substantially cylindrical shape. Meanwhile, the second joint part 22, the fourth joint part 24, and the sixth joint part 26 have a housing shape of a horizontally extending substantially cylindrical shape.

In the following description, the base unit 11, the barrel unit 12, the first arm 13, the second arm 14, the third arm 15, and the head unit 16 may be generically referred to as “arm element 1”, and the first joint part 21, the second joint part 22, the third joint part 23, the fourth joint part 24, the fifth joint part 25, the sixth joint part 26, and the seventh joint part 27 may be generically referred to as “joint part 2”.

As shown in FIG. 3, the robot arm 3 includes an accommodation part 2S for accommodating a driving mechanism 4 of the robot arm 3 with substantially the same structure in each of the plurality of joint parts 2. The driving mechanism 4 accommodated in the accommodation part 2S of each joint part 2 includes a motor 41, a reduction gear 42, a brake 43, a torque sensor 44, and a control board 45.

The motor 41 is a servo motor that serves as a driving source to pivot the arm element 1 around the pivoting axis, and includes a motor shaft 41S that generates rotational force. The reduction gear 42 reduces the number of rotations of the motor shaft 41S at a predetermined reduction ratio for transmission to a pivoting mechanism. The brake 43 applies braking to the rotation of the motor shaft 41S.

The torque sensor 44 detects the rotation torque that the motor 41 is giving to the arm element 1. That is, the torque sensor 44 detects the torque of the arm element 1 connected to the joint part 2 around the pivoting axis.

The control board 45 performs the drive control of the motor 41 based on the control signal transmitted from the control device 6, the control signal being based on the control program CP that records the setting data SD. This causes the operation of the robot arm 3 to be controlled. The setting data SD recorded in the control program CP is a data group of parameter setting values about the control of the robot 5. The parameters about the control of the robot 5 include the speed at which each arm element 1 in the robot arm 3 pivots around the pivoting axis, the torque of each arm element 1 around the pivoting axis, and the like. The control board 45 executes a plurality of operation modes including a first operation mode, a second operation mode, and a third operation mode about the drive control of the motor 41.

The first operation mode is an operation mode assuming that the operator who cooperates with the robot 5 performs work while approaching the operating range of the robot arm 3. When executing the first operation mode, the control board 45 performs drive control of the motor 41 such that the robot arm 3 continuously operates at a predetermined first speed indicated in the setting data SD in response to the control signal according to the setting data SD recorded in the control program CP.

The second operation mode is an operation mode assuming that the operator who cooperates with the robot 5 does not approach the operating range of the robot arm 3. When executing the second operation mode, the control board 45 performs the drive control of the motor 41 such that the robot arm 3 continuously operates at a second speed faster than the first speed indicated in the setting data SD in response to the control signal according to the setting data SD recorded in the control program CP.

The third operation mode is an operation mode assuming that the operator directly applies force to the robot arm 3 for guidance and teach the robot arm 3 how to operate. When executing the third operation mode, the control board 45 performs drive control of the motor 41 to regulate the operation of the robot arm 3 beyond a predetermined third speed indicated in the setting data SD in response to the control signal according to the setting data SD recorded in the control program CP.

### [Configuration of Assistance Device]

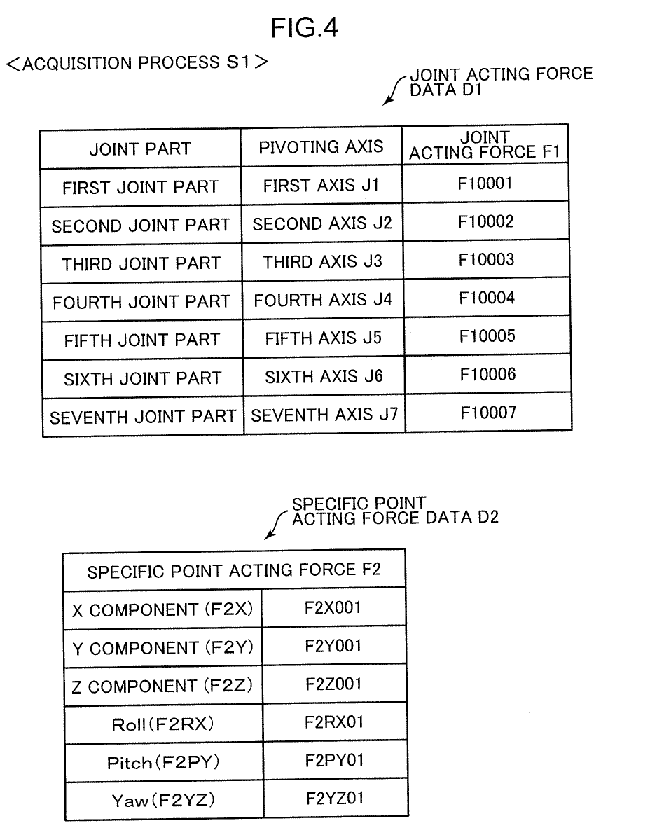

As described above, the assistance device 7 is a device that assists in setting parameters about the control of the robot 5. An operator can use the assistance device 7 to set the parameters about the control of the robot 5. The assistance device 7 will be described with reference to FIGS. 4 to 6 in addition to FIG. 1.

The assistance device 7 includes, for example, a personal computer and is equipped with an operation unit 71, a display unit 72, and a control unit 73, as shown in FIG. 1.

The display unit 72 includes, for example, a liquid crystal display or the like. The display operation of the display unit 72 is controlled by the control unit 73. The operation unit 71 includes a keyboard, a mouse, a touch panel provided in the display unit 72, or the like. The operation unit 71 receives various instructions input operations by the operator about a display mode of the display unit 72.

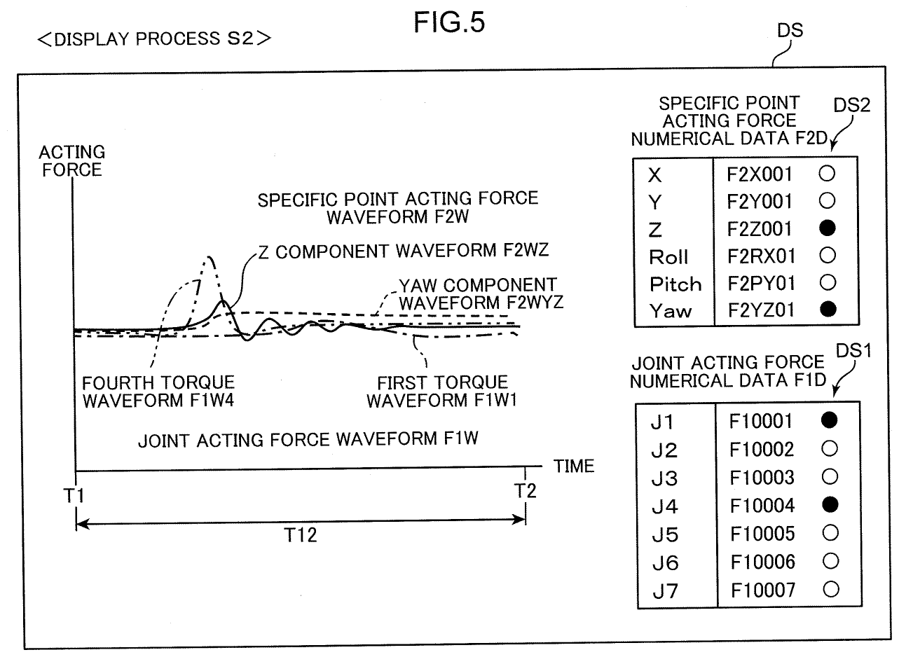

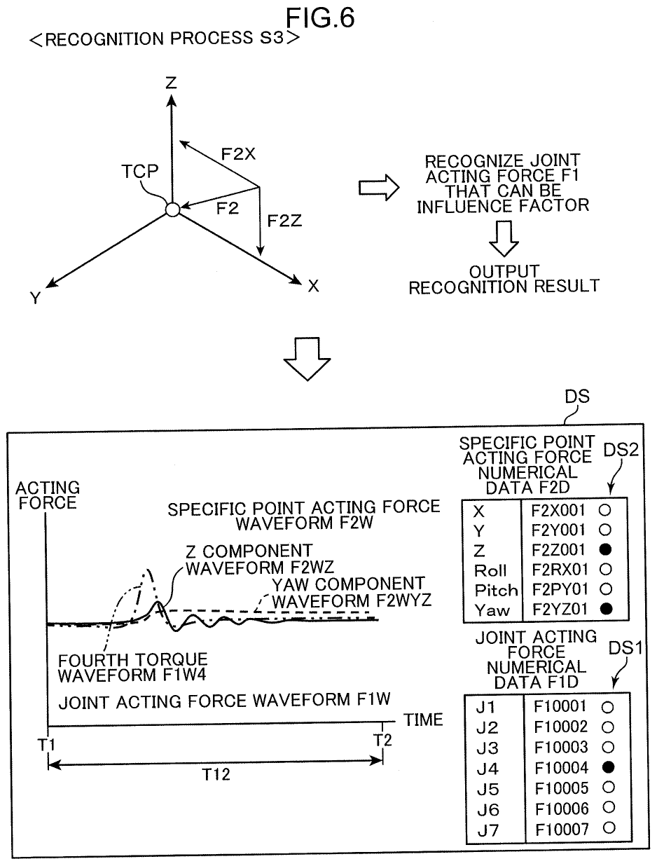

The control unit 73 includes a central processing unit (CPU), a storage area such as a hard disk drive (HDD) and a flash memory for storing an assistance control program, a random access memory (RAM) used as a working area for the CPU, and the like. The control unit 73 performs various processes such as an acquisition process S1 shown in FIG. 4, display process S2 shown in FIG. 5, recognition process S3 shown in FIG. 6 by the CPU executing the assistance control programs stored in the HDD or flash memory.

### (Acquisition Process)

In the acquisition process S1, the control unit 73 acquires joint acting force data D1 and specific point acting force data D2 shown in FIG. 4. The joint acting force data D1 is a data group of joint acting force F1 indicating force acting on each of the plurality of joint parts 2 in the robot arm 3. The specific point acting force data D2 is a data group of specific point acting force F2 indicating force acting on the specific point TCP in the head unit 16, which is the distal end of the robot arm 3.

In the present embodiment, the control unit 73 acquires the torque around the pivoting axis of each arm element 1 connected to each joint part 2 as each joint acting force F1 corresponding to each joint part 2. Specifically, the control unit 73 acquires the torque detection value detected by each torque sensor 44 corresponding to each joint part 2 as each joint acting force F1 corresponding to each joint part 2. That is, the joint acting force data D1 acquired by the control unit 73 includes each data of the torque detection value detected by each torque sensor 44 corresponding to each joint part 2.

In addition, the control unit 73 calculates the specific point acting force F2 acting on the specific point TCP based on each joint acting force F1 corresponding to each joint part 2. This allows the control unit 73 to acquire the specific point acting force data D2 indicating the data group of the specific point acting force F2. The control unit 73 acquires a component of the specific point acting force F2 in each axial direction corresponding to each of three axes, X-axis, Y-axis, and Z-axis, in the XYZ orthogonal coordinate system about the specific point TCP (three-dimensional orthogonal coordinate system) and the torque around each axis as data of the specific point acting force F2. That is, the specific point acting force data D2 acquired by the control unit 73 includes an X component F2X indicating the component in the X axial direction, a Y component F2Y indicating the component in the Y axial direction, a Z component F2Z indicating the component in the Z axial direction, a roll component F2RX indicating the torque around the X axis, a pitch component F2PY indicating the torque around the Y axis, and a yaw component F2YZ indicating the torque around the Z axis about the specific point acting force F2 acting on the specific point TCP.

Note that a force torque sensor, which is a force detector that detects the force acting on the specific point TCP at the distal end of the robot arm 3, may be attached to the robot 5. The force torque sensor measures the force in the three X, Y, and Z detection axes acting on the specific point TCP, and the torque around the three X, Y, and Z detection axes in the sensor coordinate system, which is the XYZ orthogonal coordinate system. When such a force torque sensor is attached to the robot 5, based on the measurement value measured by the force torque sensor, the control unit 73 acquires the specific point acting force data D2 including the X component F2X, Y component F2Y, Z component F2Z, roll component F2RX, pitch component F2PY, and yaw component F2YZ of the specific point acting force F2 acting on the specific point TCP.

### (Display Process)

As shown in FIG. 5, the control unit 73 controls the display unit 72 such that information for assistance in setting the parameters about the control of the robot 5 is displayed on the display screen DS of the display unit 72 in the display process S2. The control unit 73 controls the display unit 72 to display, on the display screen DS, a joint acting force waveform F1W indicating the temporal change in each joint acting force F1 corresponding to the plurality of joint parts 2, and a specific point acting force waveform F2W indicating the temporal change in the specific point acting force F2, based on the joint acting force data D1 and the specific point acting force data D2.

By the display process S2 of the control unit 73, the joint acting force waveform F1W indicating the temporal change in the joint acting force F1 acting on each joint part 2 of the robot arm 3, and the specific point acting force waveform F2W indicating the temporal change in the specific point acting force F2 acting on the specific point TCP at the distal end of the robot arm 3 are displayed on the display screen DS of the display unit 72. By checking each joint acting force waveform F1W and the specific point acting force waveform F2W displayed on the display screen DS of the display unit 72, the operator can compare the temporal change in each joint acting force F1 acting on each joint part 2 and the temporal change in the specific point acting force F2 acting on the specific point TCP at the distal end of the robot arm 3. As a result, in addition to the temporal change in the specific point acting force F2, the temporal change in each joint acting force F1 serves as indicators for setting parameters about the control of the robot 5, allowing the operator to set the parameters about the control of the robot 5 in detail.

In the present embodiment, the control unit 73 controls the display unit 72 to display each torque waveform indicating the temporal change in the torque around the pivoting axis of each arm element 1 connected to each joint part 2 of the robot arm 3 as each joint acting force waveform F1W. In this case, the joint acting force waveform F1W includes a first torque waveform corresponding to the first joint part 21, a second torque waveform corresponding to the second joint part 22, a third torque waveform corresponding to the third joint part 23, a fourth torque waveform corresponding to the fourth joint part 24, a fifth torque waveform corresponding to the fifth joint part 25, a sixth torque waveform corresponding to the sixth joint part 26, and a seventh torque waveform corresponding to the seventh joint part 27. In addition, the control unit 73 controls the display unit 72 to display each component waveform indicating the temporal change in the X component F2X, the Y component F2Y, the Z component F2Z, the roll component F2RX, the pitch component F2PY, and the yaw component F2YZ about the specific point acting force F2 acting on the specific point TCP of the robot arm 3 as the specific point acting force waveform F2W. In this case, the specific point acting force waveform F2W includes the X component waveform, the Y component waveform, the Z component waveform, the roll component waveform, the pitch component waveform, and the yaw component waveform, corresponding to each component of the specific point acting force F2.

In this aspect, each joint acting force waveform F1W as each torque waveform indicating the temporal change in the torque around the pivoting axis of each arm element 1 corresponding to each joint part 2 of the robot arm 3, and the specific point acting force waveform F2W as each component waveform indicating the temporal change in each component of the specific point acting force F2 in the XYZ orthogonal coordinate system about the specific point TCP of the robot arm 3 are displayed on the display screen DS of the display unit 72. In the example of FIG. 5, the first torque waveform F1W1 corresponding to the first joint part 21 and the fourth torque waveform F1W4 corresponding to the fourth joint part 24 are displayed in the display unit 72 as the joint acting force waveform F1W, and the Z component waveform F2WZ and the yaw component waveform F2WYZ are displayed in the display unit 72 as the specific point acting force waveform F2W. The operator checks each joint acting force waveform F1W as each torque waveform corresponding to each joint part 2 and the specific point acting force waveform F2W as each component waveform corresponding to each component of the specific point acting force F2 displayed on the display screen DS of the display unit 72. This allows the operator to compare the temporal change in the torque acting on each joint part 2 and the temporal change in each component of the specific point acting force F2 acting on the specific point TCP at the distal end of the robot arm 3.

The control unit 73 may control the display unit 72 in the display process S2 to display each joint acting force waveform F1W corresponding to each joint part 2 and the specific point acting force waveform F2W on the same time axis. In this case, each joint acting force waveform F1W and the specific point acting force waveform F2W are displayed on the same time axis on the display screen DS of the display unit 72. This allows the operator to easily compare the temporal change in each joint acting force F1 acting on each joint part 2 and the temporal change in the specific point acting force F2 acting on the specific point TCP at the distal end of the robot arm 3. Therefore, the operator can set the parameters about the control of the robot 5 efficiently.

The control unit 73 may control the display unit 72 in the display process S2 to display joint acting force numerical data F1D indicating numerical data of each joint acting force F1 on each joint acting force waveform F1W, and specific point acting force numerical data F2D indicating numerical data of the specific point acting force F2 on the specific point acting force waveform F2W on the same display screen DS as each joint acting force waveform F1W and the specific point acting force waveform F2W. The joint acting force numerical data F1D includes numerical data of each torque around the pivoting axis of each arm element 1 connected to each joint part 2 of the robot arm 3. In addition, the specific point acting force numerical data F2D includes numerical data of the X component F2X, Y component F2Y, Z component F2Z, roll component F2RX, pitch component F2PY, and yaw component F2YZ indicating each component of the specific point acting force F2 in the XYZ orthogonal coordinate system about the specific point TCP of the robot arm 3.

When comparing the temporal change in each joint acting force F1 and the temporal change in the specific point acting force F2 based on each joint acting force waveform F1W and the specific point acting force waveform F2W displayed on the display screen DS of the display unit 72, the operator can check the joint acting force numerical data F1D and the specific point acting force numerical data F2D. This allows the operator to set the parameters about the control of the robot 5 more efficiently.

In addition, the control unit 73 may control the display unit 72 in the display process S2 to display at least any one value of the maximum value, minimum value, and average value of each joint acting force F1 on each joint acting force waveform F1W in a predetermined period T12 between a first time point T1 and a second time point T2 on the time axis as the joint acting force numerical data F1D. Similarly, the control unit 73 may control the display unit 72 to display at least any one value of the maximum value, minimum value, and average value of the specific point acting force F2 on the specific point acting force waveform F2W in the predetermined period T12 between the first time point T1 and the second time point T2 on the time axis as the specific point acting force numerical data F2D. In this case, the operator can check the maximum value, minimum value, and average value of each joint acting force F1 in the predetermined period T12 as the joint acting force numerical data F1D, and can check the maximum value, minimum value, and average value of the specific point acting force F2 in the predetermined period T12 as the specific point acting force numerical data F2D.

In the present embodiment, an instruction to select the acting force waveform to be displayed in the display unit 72 may be input to the operation unit 71 in the assistance device 7, among the first to seventh torque waveforms included in the joint acting force waveform F1W, the X component waveform, the Y component waveform, the Z component waveform, the roll component waveform, the pitch component waveform, and the yaw component waveform included in the specific point acting force waveform F2W. In this case, the control unit 73 controls the display unit 72 to display the acting force waveform corresponding to the instruction input to the operation unit 71 in the display process S2.

As shown in FIG. 5, on the display screen DS of the display unit 72, a first waveform display distinguishing area DS1 is provided adjacent to the display area of the joint acting force numerical data F1D, and a second waveform display distinguishing area DS2 is provided adjacent to the display area of the specific point acting force numerical data F2D. The first waveform display distinguishing area DS1 is an area for distinguishing the first to seventh torque waveforms included in the joint acting force waveform F1W into waveforms displayed in the display unit 72 and non-displayed waveforms that are not displayed in the display unit 72 according to the selection instruction input to the operation unit 71. The second waveform display distinguishing area DS2 is an area for distinguishing the X component waveform, Y component waveform, Z component waveform, roll component waveform, pitch component waveform, and yaw component waveform included in the specific point acting force waveform F2W into waveforms displayed in the display unit 72 and non-displayed waveforms that are not displayed in the display unit 72 according to the selection instruction input to the operation unit 71.

FIG. 5 shows an example in which, as the acting force waveform to be displayed in the display unit 72, an instruction to select the first torque waveform F1W1 and the fourth torque waveform F1W4 out of the joint acting force waveform F1W, and the Z component waveform F2WZ and the yaw component waveform F2WYZ out of the specific point acting force waveform F2W is input to the operation unit 71. The operator can input, via the operation unit 71, the selection instruction of the acting force waveform to be displayed on the display screen DS of the display unit 72. Then, the operator can compare the temporal change in the joint acting force F1 and the temporal change in the specific point acting force F2 by focusing on the first torque waveform F1W1 and the fourth torque waveform F1W4 out of the joint acting force waveform F1W, and the Z component waveform F2WZ and the yaw component waveform F2WYZ out of the specific point acting force waveform F2W displayed in the display unit 72 in response to the selection instruction. This allows the operator to set the parameters about the control of the robot 5 efficiently.

### (Recognition Process)

As shown in FIG. 6, there are cases where the specific point acting force F2 disperses in the axial directions of two axes in the XYZ orthogonal coordinate system of the specific point TCP at the distal end of the robot arm 3, and the magnitude of the component of the remaining one axial direction is less than a predetermined threshold. FIG. 6 shows an example in which the specific point acting force F2 disperses in the axial directions of two axes, the X axis and the Z axis, in the XYZ orthogonal coordinate system of the specific point TCP, and the specific point acting force F2 includes the X component F2X and the Z component F2Z as components of the axial directions. In this case, out of the first to seventh torque corresponding to the first to seventh joint parts 21 to 27 of the robot arm 3, the torque that can be an influence factor of the dispersion of the specific point acting force F2 (in FIG. 6, the fourth torque corresponding to the fourth joint part 24) is an important indicator of parameter settings about the control of the robot 5.

Therefore, when it is determined that the specific point acting force F2 disperses in the axial directions of two axes in the XYZ orthogonal coordinate system of the specific point TCP, the control unit 73 recognizes the fourth torque corresponding to the fourth joint part 24 that can be an influence factor of the dispersion of the specific point acting force F2 out of the first to seventh torque corresponding to the first to seventh joint parts 21 to 27, and outputs the recognition result in the recognition process S3.

In the example of FIG. 6, by comparing the temporal change in the X component F2X and the Z component F2Z that are components of the axial directions of two axes of the specific point acting force F2 with the temporal change in the first to seventh torque corresponding to the first to seventh joint parts 21 to 27, the control unit 73 recognizes the fourth torque corresponding to the fourth joint part 24 that can be an influence factor of dispersion of the specific point acting force F2. Specifically, by comparing the rising start time, the rising speed, the maximum value in the predetermined period T12, and the like of the temporal change in the X component F2X and the Z component F2Z of the specific point acting force F2 with the temporal change in the first to seventh torque corresponding to the first to seventh joint parts 21 to 27, the control unit 73 recognizes the fourth torque that can be an influence factor of dispersion of the specific point acting force F2.

When the fourth torque corresponding to the fourth joint part 24 that can be an influence factor of the dispersion of the specific point acting force F2 is recognized, the control unit 73 outputs the recognition result. For example, the control unit 73 may control the display unit 72 based on the recognition result. Specifically, the control unit 73 controls the display unit 72 to display the fourth torque waveform F1W4 indicating the temporal change in the fourth torque corresponding to the fourth joint part 24 that can be an influence factor of dispersion of the specific point acting force F2 on the display screen DS. When the specific point acting force F2 disperses to the axial directions of two axes, the operator can set the parameter about the control of the robot 5 based on the recognition result in the recognition process S3 of the control unit 73 while focusing on the torque that can be an influence factor of dispersion of the specific point acting force F2.

As described above, the robot system 100 includes the assistance device 7 that can set the parameters about the control of the robot 5 in detail. In the robot system 100, the control device 6 can control the operation of the robot 5 by transmitting to the robot 5, the control signal according to the control program CP that records the parameter setting data SD that is set in detail about the control of the robot 5.

Note that the above-described specific embodiment mainly includes the disclosure having the following configurations.

An assistance device according to one aspect of the present disclosure is a device that assists in setting a parameter about control of a robot equipped with a robot arm including a plurality of arm elements and a plurality of joint parts that connects the plurality of arm elements pivotably around a pivoting axis, and includes a display unit and a control unit that controls the display unit. The control unit performs an acquisition process of acquiring data of joint acting force indicating force acting on each of the plurality of joint parts, and data of specific point acting force indicating force acting on a specific point at a distal end of the robot arm; and a display process of controlling the display unit to display a joint acting force waveform indicating a temporal change in each of the joint acting force and a specific point acting force waveform indicating a temporal change in the specific point acting force.

With this assistance device, the joint acting force waveform indicating the temporal change in the joint acting force acting on each joint part of the robot arm, and the specific point acting force waveform indicating the temporal change in the specific point acting force acting on the specific point at the distal end of the robot arm are displayed in the display unit. By checking each joint acting force waveform and the specific point acting force waveform displayed in the display unit, the operator can compare the temporal change in each joint acting force acting on each joint part and the temporal change in the specific point acting force acting on the specific point at the distal end of the robot arm. As a result, in addition to the temporal change in the specific point acting force, the temporal change in each joint acting force serves as indicators for setting parameters about the control of the robot, allowing the operator to set the parameters about the control of the robot in detail.

In the assistance device, the control unit may control the display unit to display each of the joint acting force waveform and the specific point acting force waveform on an identical time axis in the display process.

According to this aspect, each joint acting force waveform and the specific point acting force waveform are displayed on the identical time axis in the display unit. This allows the operator to easily compare the temporal change in each joint acting force acting on each joint part and the temporal change in the specific point acting force acting on the specific point at the distal end of the robot arm. Therefore, the operator can set the parameters about the control of the robot efficiently.

In the assistance device, the control unit may control the display unit to display numerical data of each of the joint acting force on each of the joint acting force waveform and the specific point acting force on the specific point acting force waveform on an identical screen with each of the joint acting force waveform and the specific point acting force waveform in the display process.

According to this aspect, when comparing the temporal change in each joint acting force and the temporal change in the specific point acting force based on each joint acting force waveform and the specific point acting force waveform displayed in the display unit, the operator can check the numerical data of each joint acting force and the specific point acting force. This allows the operator to set the parameters about the control of the robot more efficiently.

In the assistance device, the control unit may control the display unit to display at least any one value of a maximum value, a minimum value, and an average value of each of the joint acting force on each of the joint acting force waveform and the specific point acting force on the specific point acting force waveform in a predetermined period between a first time point and a second time point on the time axis as the numerical data in the display process.

According to this aspect, the operator can check the maximum value, minimum value, and average value of each joint acting force and the specific point acting force in the predetermined period as the numerical data.

The assistance device may further include an operation unit to which an instruction to select a waveform to cause the display unit to display is input in each of the joint acting force waveform and the specific point acting force waveform. In this case, the control unit controls the display unit to display the waveform according to the instruction input to the operation unit in the display process.

According to this aspect, the operator can input, via the operation unit, the selection instruction of the acting force waveform to be displayed in the display unit. Then, the operator can compare the temporal change in the joint acting force with the temporal change in the specific point acting force by focusing only on the acting force waveform displayed in the display unit in response to the selection instruction. This allows the operator to set the parameters about the control of the robot efficiently.

In the assistance device, the control unit may acquire torque around the pivoting axis of each of the arm elements connected to each of the plurality of joint parts as the data of each of the joint acting force, and acquire data of a component of the specific point acting force in each axial direction corresponding to each of three axes in a three-dimensional orthogonal coordinate system about the specific point in the acquisition process. In addition, the control unit may control the display unit to display a temporal change in each of the torque corresponding to each of the plurality of joint parts as each of the joint acting force waveform, and to display a temporal change in the component of the specific point acting force in each axial direction as the specific point acting force waveform in the display process.

According to this aspect, each torque waveform indicating the temporal change in the torque around the pivoting axis of each arm element corresponding to each joint part of the robot arm, and each component waveform indicating the temporal change in each component in each axial direction of the specific point acting force in the three-dimensional orthogonal coordinate system about the specific point are displayed in the display unit. By checking each torque waveform corresponding to each joint part and each component waveform corresponding to the component in each axial direction of the specific point acting force displayed in the display unit, the operator can compare the temporal change in the torque acting on each joint part and the temporal change in each component of the specific point acting force acting on the specific point at the distal end of the robot arm.

In the assistance device, based on magnitude of the component of the specific point acting force in each axial direction, when it is determined that the specific point acting force disperses in axial directions of two axes in the three-dimensional orthogonal coordinate system of the specific point, the control unit may perform a recognition process to recognize torque that is possible to be an influence factor of the dispersion of the specific point acting force out of each of the torque corresponding to each of the plurality of joint parts, and to output a result of the recognition.

In the three-dimensional orthogonal coordinate system of the specific point at the distal end of the robot arm, when the specific point acting force disperses to the axial directions of two axes, out of the torque around the pivoting axis of each arm element corresponding to each joint part of the robot arm, the torque that can be an influence factor of the dispersion of the specific point acting force is an important indicator for setting the parameter about the control of the robot. Therefore, in the recognition process, the control unit recognizes the torque that can be an influence factor of the dispersion of the specific point acting force, and outputs the recognition result. For example, by comparing the temporal change in the component in the axial directions of two axes of the specific point acting force with the temporal change in each torque corresponding to each joint part, the control unit recognizes the torque that can be an influence factor of the dispersion of the specific point acting force. Specifically, by comparing the rising start time, the rising speed, the maximum value in the predetermined period, and the like of the temporal change in each component of the specific point acting force with the temporal change in each torque corresponding to each joint part, the control unit recognizes the torque that can be an influence factor of dispersion of the specific point acting force. When the specific point acting force disperses to the axial directions of two axes, the operator can set the parameter about the control of the robot based on the recognition result in the recognition process of the control unit while focusing on the torque that can be an influence factor of dispersion of the specific point acting force.

A robot system according to another aspect of the present disclosure includes: a robot equipped with a robot arm including a plurality of arm elements and a plurality of joint parts that connects the plurality of arm elements pivotably around a pivoting axis; and the assistance device that assists in creating setting data about control of the robot.

This robot system includes the assistance device that can set the parameters about the control of the robot in detail. The robot system can control the operation of the robot arm based on the parameter setting values that are set in detail about the control of the robot.

As described above, the present disclosure can provide the assistance device that can set parameters about the control of the robot in detail and the robot system.

1. An assistance device that assists in setting a parameter about control of a robot equipped with a robot arm including a plurality of arm elements and a plurality of joint parts that connects the plurality of arm elements pivotably around a pivoting axis, the assistance device comprising:
a display; and
a controller configured to control the display by performing
an acquisition process of acquiring data of joint acting force indicating force acting on each of the plurality of joint parts, and data of specific point acting force indicating force acting on a specific point at a distal end of the robot arm; and
a display process of controlling the display to display a joint acting force waveform indicating a temporal change in each of the joint acting force and a specific point acting force waveform indicating a temporal change in the specific point acting force.

2. The assistance device according to claim 1, wherein the controller is configured to control the display to display each of the joint acting force waveform and the specific point acting force waveform on an identical time axis in the display process.

3. The assistance device according to claim 2, wherein the controller is configured to control the display to display numerical data of each of the joint acting force on each of the joint acting force waveform and the specific point acting force on the specific point acting force waveform on an identical screen with each of the joint acting force waveform and the specific point acting force waveform in the display process.

4. The assistance device according to claim 3, wherein the controller is configured to control the display to display at least any one value of a maximum value, a minimum value, and an average value of each of the joint acting force on each of the joint acting force waveform and the specific point acting force on the specific point acting force waveform in a predetermined period between a first time point and a second time point on the time axis as the numerical data in the display process.

5. The assistance device according to claim 1, further comprising an operation unit to which an instruction to select a waveform to cause the display to display is input in each of the joint acting force waveform and the specific point acting force waveform,
wherein the controller is configured to control the display to display the waveform according to the instruction input to the operation unit in the display process.

6. The assistance device according to claim 1, wherein the controller is configured to
acquire torque around the pivoting axis of each of the arm elements connected to each of the plurality of joint parts as the data of each of the joint acting force, and acquire data of a component of the specific point acting force in each axial direction corresponding to each of three axes in a three-dimensional orthogonal coordinate system about the specific point in the acquisition process, and
control the display to display a temporal change in each of the torque corresponding to each of the plurality of joint parts as each of the joint acting force waveform, and to display a temporal change in the component of the specific point acting force in each axial direction as the specific point acting force waveform in the display process.

7. The assistance device according to claim 6, wherein based on magnitude of the component of the specific point acting force in each axial direction, when it is determined that the specific point acting force disperses in axial directions of two axes in the three-dimensional orthogonal coordinate system of the specific point, the controller is configured to perform a recognition process to recognize torque that is possible to be an influence factor of the dispersion of the specific point acting force out of each of the torque corresponding to each of the plurality of joint parts, and to output a result of the recognition.

8. A robot system comprising:
a robot equipped with a robot arm including a plurality of arm elements and a plurality of joint parts that connects the plurality of arm elements pivotably around a pivoting axis; and
the assistance device according to claim 1 that assists in creating setting data about control of the robot.

9. An assistance device that assists in setting a parameter about control of a robot equipped with a robot arm including a plurality of arm elements and a plurality of joint parts that connects the plurality of arm elements pivotably around a pivoting axis, the parameter including torque around the pivoting axis of each of the arm elements, the assistance device comprising:
a display; and
a controller configured to control the display by performing
an acquisition process of acquiring the torque around the pivoting axis of each of the arm elements as data of joint acting force indicating force acting on each of the plurality of joint parts, and acquiring data of specific point acting force by calculating the specific point acting force indicating force acting on a specific point at a distal end of the robot arm based on each of the joint acting force; and
a display process of controlling the display to display a temporal change in each of the torque corresponding to each of the plurality of joint parts as a joint acting force waveform indicating a temporal change in each of the joint acting force, and to display a specific point acting force waveform indicating a temporal change in the specific point acting force.

10. The assistance device according to claim 9, wherein the controller is configured to
acquire data of a component of the specific point acting force in each axial direction corresponding to each of three axes in a three-dimensional orthogonal coordinate system about the specific point in the acquisition process; and
control the display to display a temporal change in the component of the specific point acting force in each axial direction as the specific point acting force waveform in the display process.

11. The assistance device according to claim 10, wherein based on magnitude of the component of the specific point acting force in each axial direction, when it is determined that the specific point acting force disperses in axial directions of two axes in the three-dimensional orthogonal coordinate system of the specific point, the controller is configured to perform a recognition process to recognize torque that is possible to be an influence factor of the dispersion of the specific point acting force out of each of the torque corresponding to each of the plurality of joint parts, and to output a result of the recognition.

12. A robot system comprising:
a robot equipped with a robot arm including a plurality of arm elements and a plurality of joint parts that connects the plurality of arm elements pivotably around a pivoting axis; and
the assistance device according to claim 9 that assists in setting the parameter including the torque around the pivoting axis of each of the arm elements about control of the robot.

13. A robot system comprising:
a robot equipped with a robot arm including a plurality of arm elements and a plurality of joint parts that connects the plurality of arm elements pivotably around a pivoting axis; and
the assistance device according to claim 2 that assists in creating setting data about control of the robot.

14. A robot system comprising:
a robot equipped with a robot arm including a plurality of arm elements and a plurality of joint parts that connects the plurality of arm elements pivotably around a pivoting axis; and
the assistance device according to claim 3 that assists in creating setting data about control of the robot.

15. A robot system comprising:
a robot equipped with a robot arm including a plurality of arm elements and a plurality of joint parts that connects the plurality of arm elements pivotably around a pivoting axis; and
the assistance device according to claim 4 that assists in creating setting data about control of the robot.

16. A robot system comprising:
a robot equipped with a robot arm including a plurality of arm elements and a plurality of joint parts that connects the plurality of arm elements pivotably around a pivoting axis; and
the assistance device according to claim 5 that assists in creating setting data about control of the robot.

17. A robot system comprising:
a robot equipped with a robot arm including a plurality of arm elements and a plurality of joint parts that connects the plurality of arm elements pivotably around a pivoting axis; and
the assistance device according to claim 6 that assists in creating setting data about control of the robot.

18. A robot system comprising:
a robot equipped with a robot arm including a plurality of arm elements and a plurality of joint parts that connects the plurality of arm elements pivotably around a pivoting axis; and
the assistance device according to claim 7 that assists in creating setting data about control of the robot.

19. A robot system comprising:
a robot equipped with a robot arm including a plurality of arm elements and a plurality of joint parts that connects the plurality of arm elements pivotably around a pivoting axis; and
the assistance device according to claim 10 that assists in setting the parameter including the torque around the pivoting axis of each of the arm elements about control of the robot.

20. A robot system comprising:
a robot equipped with a robot arm including a plurality of arm elements and a plurality of joint parts that connects the plurality of arm elements pivotably around a pivoting axis; and
the assistance device according to claim 11 that assists in setting the parameter including the torque around the pivoting axis of each of the arm elements about control of the robot.
